(19) United States
(12) Patent Application Publication
(10) Pub. No.: US 2025/0318580 A1
(43) Pub. Date: Oct. 16, 2025

(54) AEROSOL GENERATING DEVICE COMPRISING A LEVEL SENSOR

(71) Applicant: KT & G CORPORATION, Daejeon (KR)

(72) Inventors: Youn Ji SHIN, Seoul (KR); Hwan Hee Jeong, Goyang-si (KR); Taehun Kim, Yongin-si (KR); Jueon Park, Seongnam-si (KR); Hunil Lim, Seoul (KR); HyungJin Jung, Seoul (KR)

(73) Assignee: KT & G CORPORATION, Daejeon (KR)

(21) Appl. No.: 19/169,092

(22) Filed: Apr. 3, 2025

(30) Foreign Application Priority Data
Apr. 15, 2024 (KR) 10-2024-0049886

(51) Int. Cl. A24F 40/51; A24F 40/10; A24F 40/42; G01F 23/26

(52) U.S. Cl. CPC A24F 40/51; A24F 40/10; A24F 40/42; G01F 23/26

(57) ABSTRACT

A method and apparatus are provided. An aerosol-generating device includes a chamber configured to store a liquid aerosol-generating material, a main body including a partition wall facing the chamber, a conductive member provided on one surface of the chamber facing the partition wall, and a level sensor configured to sense an amount of the liquid aerosol-generating material stored in the chamber, in which the level sensor is configured to sense the amount of the liquid aerosol-generating material by applying current to the conductive member and measuring a voltage value that varies depending on a capacity of the liquid aerosol-generating material.

### CROSS-REFERENCE TO RELATED APPLICATION

This application claims priority from Korean Patent Application No. 10-2024-0049886, filed on Apr. 15, 2024, in the Korean Intellectual Property Office, the disclosure of which is incorporated herein by reference in its entirety.

### BACKGROUND

### 1. Field

Methods and apparatuses consistent with embodiments relate to an aerosol-generating device including a level sensor.

### 2. Description of the Related Art

Recently, the demand for alternative articles to overcome the disadvantages of traditional cigarettes has increased. For example, there is an increasing demand for devices that generate an aerosol by electrically heating a cigarette stick (e.g., cigarette-like electronic cigarettes). Accordingly, research on a cigarette stick (or an aerosol-generating article) and an electrically heated aerosol-generating device into which the cigarette stick is inserted is being actively conducted.

The above description is information the inventor(s) acquired during the course of conceiving the present disclosure, or already possessed at the time, and was not necessarily publicly known before the present application was filed.

### SUMMARY

One or more embodiments may address at least the above problems and/or disadvantages and other disadvantages not described above. Also, the embodiments are not required to overcome the disadvantages described above, and an embodiment may not overcome any of the problems described above.

An aerosol-generating device may accommodate a liquid aerosol-generating material in a chamber and atomize the liquid aerosol-generating material. As the liquid aerosol-generating material is consumed, the aerosol-generating device may sense an amount of the liquid aerosol-generating material remaining in the chamber and display the change in the capacity of the liquid aerosol-generating material.

However, the dielectric constant of a liquid aerosol-generating material may change depending on various factors, such as a raw material, concentration, and composition ratio of the liquid aerosol-generating material, and thus, errors may occur in the detection result of the remaining amount of the liquid aerosol-generating material.

According to an aspect of an embodiment, there is provided an aerosol-generating device including a chamber configured to store a liquid aerosol-generating material, a main body including a partition wall facing the chamber, a conductive member provided on one surface of the chamber facing the partition wall, and a level sensor configured to sense an amount of the liquid aerosol-generating material stored in the chamber, in which the level sensor is configured to sense the amount of the liquid aerosol-generating material by applying current to the conductive member and measuring a voltage value that varies depending on a capacity of the liquid aerosol-generating material.

The level sensor may include a unit of electrodes disposed to face the conductive member and configured to apply current to the conductive member.

The conductive member may be formed in a bar shape extending along a direction in which the chamber extends.

The conductive member may include a first conductive region and a second conductive region disposed to be spaced apart from each other.

The first conductive region and the second conductive region may be arranged parallel to each other.

The first conductive region and the second conductive region may be formed in the same shape.

The aerosol-generating may further include at least one processor configured to receive a detection result from the level sensor and configured to control driving of the aerosol-generating device, in which the at least one processor may be configured to receive detection results of each of the first conductive region and the second conductive region and configured to correct the detection result of the level sensor.

The at least one processor may be configured to correct the detection result of the level sensor by an average value of the detection results of each of the first conductive region and the second conductive region.

The aerosol-generating device may further include an insulating region provided between the first conductive region and the second conductive region.

The conductive member may be formed in a shape that is bent at least one time and extends along a direction in which the chamber extends.

The conductive member may be coupled to the chamber in a structure protruding from the one surface of the chamber.

The chamber may include a groove region formed in one surface to which the conductive member is coupled and configured to accommodate the conductive member.

The conductive member may be disposed inside the groove region so that the one surface of the chamber and the conductive member form a flat surface.

The chamber may be formed of a conductive resin, a conductive polymer material, or a conductive organic chemical.

The chamber may be formed of a conductive material having relatively lower conductivity than the conductive member.

According to an embodiment of the present disclosure, an aerosol-generating device may improve the detection accuracy of a level sensor that senses an amount of a liquid aerosol-generating material inside a chamber by a conductive member provided on an outer circumferential surface of the chamber.

Additionally, according to an embodiment, an aerosol-generating device may correct the detection result of a level sensor by using a plurality of conductive members and may dispose the plurality of conductive members in various ways.

The effects of the aerosol-generating device according to an embodiment are not limited to the above-mentioned effects, and other unmentioned effects can be clearly understood from the following description by one of ordinary skill in the art.

### BRIEF DESCRIPTION OF THE DRAWINGS

The accompanying drawings illustrate desired embodiments of the present disclosure and are provided together with the detailed description for better understanding of the technical idea of the present disclosure. Therefore, the present disclosure should not be construed as being limited to the embodiments set forth in the drawings.

FIG. 1 is a block diagram illustrating an aerosol-generating device according to an embodiment;

FIG. 2 is a perspective view illustrating an aerosol-generating device according to an embodiment;

FIG. 3 is an exploded perspective view illustrating an aerosol-generating device according to an embodiment;

FIG. 4 is an exploded perspective view illustrating a cartridge of an aerosol-generating device, according to an embodiment;

FIG. 5 is a cross-sectional view illustrating a cartridge of an aerosol-generating device, according to an embodiment;

FIG. 6 is a partial cross-sectional view illustrating an aerosol-generating device according to an embodiment;

FIG. 7A is a perspective view illustrating a cartridge of an aerosol-generating device, according to an embodiment;

FIG. 7B is a perspective view illustrating a cartridge of an aerosol-generating device, according to an embodiment;

FIG. 7C is a perspective view illustrating a cartridge of an aerosol-generating device, according to an embodiment; and

FIG. 7D is a perspective view illustrating a cartridge of an aerosol-generating device, according to an embodiment.

### DETAILED DESCRIPTION

Description will now be given in detail according to embodiments set forth herein with reference to the accompanying drawings. The same or equivalent components may be denoted by the same reference numerals, and description thereof will not be repeated.

Suffixes such as “module” and “unit” used for components in the following description are assigned or interchangeably used to facilitate description of the specification and do not have any special meanings or functions.

Further, in the description of embodiments set forth herein, a detailed description of well-known related arts will be omitted when it is deemed that such description will cause ambiguous interpretation of the embodiments. Further, the accompanying drawings are merely intended for easier understanding of the embodiments set forth herein, and the technical idea of the present disclosure is not limited thereto, and the embodiments should be understood to include all changes, equivalents, and replacements within the idea and the technical scope of the disclosure.

Terms, such as first, second, and the like, may be used to describe various components, but the components should not be limited by these terms. These terms are only used to distinguish one component from another component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Also, the singular forms “a”, “an”, and “the” are intended to include the plural forms as well, unless the context clearly indicates otherwise.

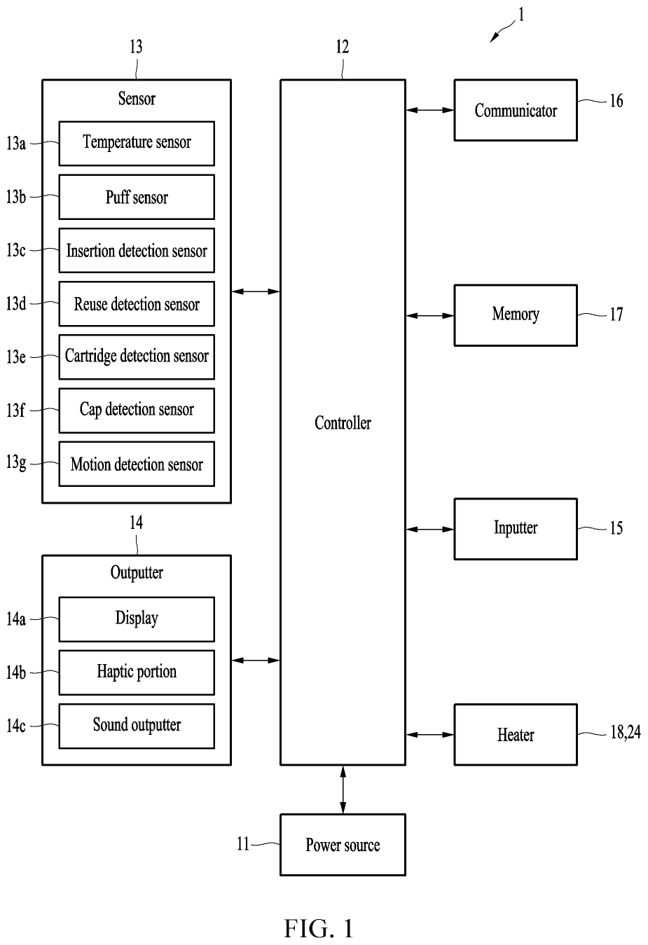

FIG. 1 is a block diagram illustrating an aerosol-generating device 1 according to an embodiment.

Referring to FIG. 1, according to an embodiment, the aerosol-generating device 1 may include a power source 11, a controller 12, a sensor 13, an outputter 14, an inputter 15, a communicator 16, a memory 17, and at least one heater (e.g., a heater 18 or a cartridge heater 24).

However, the internal structure of the aerosol-generating device 1 is not limited to what is shown in FIG. 1. It is to be understood by one of ordinary skill in the art to which the disclosure pertains that some of the components shown in FIG. 1 may be omitted or new components may be added according to the design of the aerosol-generating device 1.

In an embodiment, the sensor 13 may sense a state of the aerosol-generating device 1 or a state around the aerosol-generating device 1 and may transmit the sensed information to the controller 12. The controller 12 may control the aerosol-generating device 1 based on the sensed information so that various functions, such as operations of controlling the cartridge heater 24 and/or the heater 18, limiting smoking, determining whether a stick and/or a cartridge is inserted, and displaying a notification, are performed.

In an embodiment, the sensor 13 may include at least one of a temperature sensor 13a, a puff sensor 13b, an insertion detection sensor 13c, a reuse detection sensor 13d, a cartridge detection sensor 13e, a cap detection sensor 13f, and a motion detection sensor 13g.

In an embodiment, the temperature sensor 13a may sense the temperature at which the cartridge heater 24 and/or the heater 18 is heated. The aerosol-generating device 1 may include a separate temperature sensor that senses the temperature of the cartridge heater 24 and/or the heater 18, or the cartridge heater 24 and/or the heater 18 itself may serve as a temperature sensor.

In an embodiment, the temperature sensor 13a may output a signal corresponding to the temperature of the cartridge heater 24 and/or the heater 18. For example, the temperature sensor 13a may include a resistance element of which a resistance value changes in response to a change in the temperature of the cartridge heater 24 and/or the heater 18. The temperature sensor 13a may be implemented by a thermistor, which is an element that uses the property that the resistance changes depending on the temperature. Here, the temperature sensor 13a may output a signal corresponding to the resistance value of the resistance element as a signal corresponding to the temperature of the cartridge heater 24 and/or the heater 18.

For example, the temperature sensor 13a may be configured as a sensor that detects a resistance value of the cartridge heater 24 and/or the heater 18. Here, the temperature sensor 13a may output a signal corresponding to the resistance value of the cartridge heater 24 and/or the heater 18 as a signal corresponding to the temperature of the cartridge heater 24 and/or the heater 18.

In an embodiment, the temperature sensor 13a may be disposed around the power source 11 to monitor the temperature of the power source 11. The temperature sensor 13a may be disposed adjacent to the power source 11. For example, the temperature sensor 13a may be attached to one surface of a battery, which is the power source 11. For example, the temperature sensor 13a may be mounted on one surface of a printed circuit board.

In an embodiment, the temperature sensor 13a may be disposed inside the body of the aerosol-generating device 1 and may sense the internal temperature of the body.

In an embodiment, the puff sensor 13b may sense a puff of a user based on various physical changes in an airflow path. The puff sensor 13b may output a signal corresponding to the puff. For example, the puff sensor 13b may be a pressure sensor. The puff sensor 13b may output a signal corresponding to the internal pressure of the aerosol-generating device 1. Here, the internal pressure of the aerosol-generating device 1 may correspond to the pressure in the airflow path through which a gas flows. The puff sensor 13b may be disposed corresponding to the airflow path through which a gas flows in the aerosol-generating device 1.

In an embodiment, the insertion detection sensor 13c may sense the insertion and/or removal of a stick. The insertion detection sensor 13c may sense a change in signal as the stick is inserted and/or removed. The insertion detection sensor 13c may be installed around an insertion space. The insertion detection sensor 13c may sense the insertion and/or removal of the stick according to a change in dielectric constant inside of the insertion space. For example, the insertion detection sensor 13c may be an inductive sensor and/or a capacitance sensor.

In an embodiment, the inductive sensor may include at least one coil. The coil of the inductive sensor may be disposed adjacent to the insertion space. For example, when the magnetic field changes around the coil through which current flows, the properties of the current flowing through the coil may change according to Faraday's law of electromagnetic induction. Here, the properties of the current flowing through the coil may include a frequency of alternating current, a current value, a voltage value, an inductance value, an impedance value, and the like.

In an embodiment, the inductive sensor may output a signal corresponding to the properties of the current flowing through the coil. For example, the inductive sensor may output a signal corresponding to the inductance value of the coil.

In an embodiment, the capacitance sensor may include a conductor. The conductor of the capacitance sensor may be disposed adjacent to the insertion space. The capacitance sensor may output a signal corresponding to the electromagnetic properties of the surroundings, for example, the capacitance around the conductor. For example, when a stick including a wrapper including a metal is inserted into the insertion space, the electromagnetic properties around the conductor may be changed by the wrapper of the stick.

In an embodiment, the reuse detection sensor 13d may sense whether the stick is reused. The reuse detection sensor 13d may be a color sensor. The color sensor may sense the color of the stick. The color sensor may sense the color of a portion of the wrapper that wraps around the outside of the stick. The color sensor may detect a value of the optical properties corresponding to the color of an object based on light reflected from the object. For example, the optical properties may be a wavelength of light. The color sensor may be implemented as a single component in conjunction with a proximity sensor or may be implemented as a separate component that is different from the proximity sensor.

In an embodiment, at least a portion of the wrapper of the stick may change in color due to an aerosol. The reuse detection sensor 13d may be disposed at a location corresponding to the location at which at least a portion of the wrapper that changes in color due to an aerosol is disposed when the stick is inserted into the insertion space. For example, before the stick is used by the user, the color of at least a portion of the wrapper may be a first color. Here, as at least a portion of the wrapper is wet by the aerosol while the aerosol generated by the aerosol-generating device 1 passes through the stick, the color of the portion of the wrapper may change to a second color. Furthermore, the color of the portion of the wrapper may be maintained as the second color after changing from the first color to the second color.

In an embodiment, the cartridge detection sensor 13e may sense the mounting and/or removal of a cartridge. The cartridge detection sensor 13e may be implemented by an inductance-based sensor, a capacitive sensor, a resistance sensor, or a Hall sensor (e.g., Hall IC) using the Hall effect.

In an embodiment, the cap detection sensor 13f may sense the mounting and/or removal of a cap. When the cap is separated from the body, a portion of the cartridge and the body covered by the cap may be exposed to the outside. The cap detection sensor 13f may be implemented by a contact sensor, a Hall sensor (e.g., Hall IC), an optical sensor, or the like.

In an embodiment, the motion detection sensor 13g may sense the motion of the aerosol-generating device 1. The motion detection sensor 13g may be implemented by at least one of an acceleration sensor and a gyro sensor.

In an embodiment, in addition to the sensors described above, the sensor 13 may further include at least one of a humidity sensor, a barometric sensor, a magnetic sensor, a position sensor (e.g., global positioning system (GPS)), and a proximity sensor. A function of each sensor may be intuitively inferable from its name by one of ordinary skill in the art, and thus, a detailed description thereof is omitted herein.

In an embodiment, the outputter 14 may output information about the state of the aerosol-generating device 1 and provide the information to the user. The outputter 14 may include at least one of a display 14a, a haptic portion 14b, and a sound outputter 14c but is not limited thereto. When the display 14a and a touchpad are provided in a layered structure to form a touchscreen, the display 14a may be used as an input device in addition to an output device.

In an embodiment, the display 14a may visually provide information about the aerosol-generating device 1 to the user.

For example, the information about the aerosol-generating device 1 may include, for example, a charging/discharging state of the power source 11 of the aerosol-generating device 1, a preheating state of the heater 18, an insertion/removal state of the stick and/or the cartridge, a mounting/removal state of the cap, or a limited usage state (e.g., an abnormal article detected) of the aerosol-generating device 1, or the like, and the display 14a may externally output the information. For example, the display 14a may be in the form of a light-emitting diode (LED) device. The display 14a may be, for example, a liquid-crystal display panel (LCD), an organic light-emitting display panel (OLED), or the like.

In an embodiment, the haptic portion 14b may provide information about the aerosol-generating device 1 to the user in a haptic way by converting an electrical signal into a mechanical stimulus or an electrical stimulus. For example, the haptic portion 14b may generate vibrations corresponding to the completion of initial preheating when initial power is supplied to the cartridge heater 24 and/or the heater 18 for a set time. The haptic portion 14b may include a vibration motor, a piezoelectric element, or an electrical stimulation device.

In an embodiment, the sound outputter 14c may provide the information about the aerosol-generating device 1 to the user in an auditory way. For example, the sound outputter 14c may convert an electrical signal into a sound signal and externally output the sound signal.

In an embodiment, the power source 11 may supply power to be used to operate the aerosol-generating device 1. The power source 11 may supply power to heat the cartridge heater 24 and/or the heater 18. In addition, the power source 11 may supply power required for operations of the other components (e.g., the sensor 13, the outputter 14, the inputter 15, the communicator 16, and the memory 17) included in the aerosol-generating device 1. The power source 11 may be a rechargeable battery or a disposable battery. The power source 11 may be, for example, a lithium polymer (LiPoly) battery but is not limited thereto.

Although not shown in FIG. 1, the aerosol-generating device 1 may further include a power protection circuit. The power protection circuit may be electrically connected to the power source 11 and may include a switching element.

In an embodiment, the power protection circuit may cut off an electrical circuit for the power source 11 under a predetermined condition. For example, the power protection circuit may cut off the electrical circuit for the power source 11 when the voltage level of the power source 11 is greater than or equal to first voltage corresponding to overcharging. For example, the power protection circuit may cut off the electrical circuit for the power source 11 when the voltage level of the power source 11 is less than second voltage corresponding to overdischarging.

In an embodiment, the heater 18 may receive power from the power source 11 to heat a medium or an aerosol-generating material in the stick. Although not shown in FIG. 1, the aerosol-generating device 1 may further include a power conversion circuit (e.g., a direct current (DC)-to-DC (DC/DC) converter) that converts power of the power source 11 and supplies the power to the cartridge heater 24 and/or the heater 18. In addition, when the aerosol-generating device 1 generates an aerosol in an induction heating manner, the aerosol-generating device 1 may further include a DC-to-alternating current (AC) (DC/AC) converter that converts DC power of the power source 11 into AC power.

In an embodiment, the controller 12, the sensor 13, the outputter 14, the inputter 15, the communicator 16, and the memory 17 may receive power from the power source 11 to perform functions. Although not shown in FIG. 1, a power conversion circuit, for example, a low dropout (LDO) circuit or a voltage regulator circuit, which converts power of the power source 11 and supplies the power to respective components, may further be included. In addition, although not shown in FIG. 1, a noise filter may be provided between the power source 11 and the heater 18. The noise filter may be a low-pass filter. The low-pass filter may include at least one inductor and a capacitor. The cutoff frequency of the low-pass filter may correspond to the frequency of high-frequency switching current applied from the power source 11 to the heater 18. The low-pass filter may prevent the application of a high-frequency noise component to the sensor 13, such as the insertion detection sensor 13c.

In an embodiment, the cartridge heater 24 and/or the heater 18 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 18 may be implemented as a metal heating wire, a metal heating plate on which an electrically conductive track is arranged, a ceramic heating structure, or the like. However, embodiments are not limited thereto.

In an embodiment, the heater 18 may be an induction heater. For example, the heater 18 may include a susceptor that heats the aerosol-generating material by generating heat through a magnetic field applied by a coil.

In an embodiment, the inputter 15 may receive information input from the user or output information to the user. For example, the inputter 15 may be a touch panel. The touch panel may include at least one touch sensor for sensing a touch. For example, the touch sensor may include a capacitive touch sensor, a resistive touch sensor, a surface acoustic wave touch sensor, an infrared touch sensor, and the like but is not limited thereto.

In an embodiment, the display 14a and the touch panel may be implemented as a single panel. For example, the touch panel may be inserted into the display 14a (e.g., an on-cell type or in-cell type). For example, the touch panel may be added onto the display 14a (e.g., an add-on type).

Furthermore, the inputter 15 may include a button, a keypad, a dome switch, a jog wheel, a jog switch, and the like but is not limited thereto.

In an embodiment, the memory 17, which is hardware for storing various pieces of data processed in the aerosol-generating device 1, may store data processed by the controller 12 and data to be processed thereby. The memory 17 may include at least one type of storage medium of flash memory type memory, hard disk type memory, multimedia card micro type memory, card type memory (e.g., secure digital (SD) or extreme digital (XD) memory), random-access memory (RAM), static RAM (SRAM), read-only memory (ROM), electrically erasable programmable ROM (EEPROM), programmable ROM (PROM), magnetic memory, a magnetic disk, or an optical disk. The memory 17 may store an operating time of the aerosol-generating device 1, a maximum number of puffs, a current number of puffs, at least one temperature profile, data associated with a smoking pattern of the user, and the like.

In an embodiment, the communicator 16 may include at least one component for communicating with another electronic device. For example, the communicator 16 may include at least one of a short-range wireless communication unit and a wireless communication unit.

In an embodiment, the short-range wireless communication unit may include a Bluetooth communication unit, a Bluetooth low-energy (BLE) communication unit, a near field communication unit, a wireless local area network (WLAN) (wireless-fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

In an embodiment, the wireless communication unit may include, for example, a cellular network communication unit, an Internet communication unit, a computer network (e.g., a local area network (LAN) or a wide-area network (WAN)) communication unit, or the like. However, embodiments are not limited thereto.

Although not shown in FIG. 1, the aerosol-generating device 1 may further include a connection interface such as a universal serial bus (USB) interface and may be connected to another external device through the connection interface such as a USB interface to transmit and receive information or to charge the power source 11.

In an embodiment, the controller 12 may control the overall operation of the aerosol-generating device 1. In an embodiment, the controller 12 may include at least one processor. The processor may be implemented as an array of a plurality of logic gates or may be implemented as a combination of a general-purpose microprocessor and a memory in which a program executable by the microprocessor is stored. In addition, it is to be understood by one of ordinary skill in the art to which the present disclosure pertains that the processor may be implemented in other types of hardware.

In an embodiment, the controller 12 may control the temperature of the heater 18 by controlling the supply of power from the power source 11 to the heater 18. The controller 12 may control the temperature of the cartridge heater 24 and/or the heater 18 based on the temperature of the cartridge heater 24 and/or the heater 18 sensed by the temperature sensor 13a. The controller 12 may adjust the power supplied to the cartridge heater 24 and/or the heater 18 based on the temperature of the cartridge heater 24 and/or the heater 18. For example, the controller 12 may determine a target temperature for the cartridge heater 24 and/or the heater 18 based on a temperature profile stored in the memory 17.

In an embodiment, the aerosol-generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil 181. The power supply circuit may include at least one switching element. The switching element may be implemented by a bipolar junction transistor (BJT), a field effective transistor (FET), or the like. The controller 12 may control the power supply circuit.

In an embodiment, the controller 12 may control the supply of power by controlling the switching of the switching element of the power supply circuit. The power supply circuit may be an inverter for converting DC power output from the power source 11 into AC power. For example, the inverter may be configured as a half-bridge circuit or a full-bridge circuit including a plurality of switching elements.

In an embodiment, the controller 12 may turn on the switching element to supply power from the power source 11 to the cartridge heater 24 and/or the heater 18. The controller 12 may turn off the switching element to cut off the supply of power to the cartridge heater 24 and/or the heater 18. The controller 12 may adjust the current supplied from the power source 11 by adjusting the frequency and/or duty ratio of the current pulse input to the switching element.

In an embodiment, the controller 12 may control the voltage output from the power source 11 by controlling the switching of the switching element of the power supply circuit. The power conversion circuit may convert the voltage output from the power source 11. For example, the power conversion circuit may include a buck converter for decreasing the voltage output from the power source 11. For example, the power conversion circuit may be implemented through a buck-boost converter, a Zener diode, or the like.

In an embodiment, the controller 12 may adjust the level of voltage output from the power conversion circuit by controlling an ON/OFF operation of the switching element included in the power conversion circuit. During the ON state of the switching element, the level of voltage output from the power conversion circuit may correspond to the level of voltage output from the power source 11. The duty ratio for the ON/OFF operation of the switching element may correspond to the ratio of the voltage output from the power conversion circuit to the voltage output from the power source 11. As the duty ratio for the ON/OFF operation of the switching element decreases, the level of voltage output from the power conversion circuit may decrease. The heater 18 may be heated based on the voltage output from the power conversion circuit.

In an embodiment, the controller 12 may control to supply power to the heater 18 using at least one of a pulse width modulation (PWM) scheme and a proportional-integral-differential (PID) scheme.

For example, the controller 12 may control to supply a current pulse with a predetermined frequency and a duty ratio to the heater 18, using the PWM scheme. The controller 12 may control the power supplied to the heater 18 by adjusting the frequency and duty ratio of the current pulse.

For example, the controller 12 may determine a target temperature, which is the target of the controlling, based on the temperature profile. The controller 12 may control the power supplied to the heater 18 using the PID scheme, which is a feedback control scheme through the difference value between the temperature of the heater 18 and the target temperature, the value obtained by integrating the difference value over time, and the value obtained by differentiating the difference value over time.

In an embodiment, the controller 12 may prevent overheating of the cartridge heater 24 and/or the heater 18. For example, the controller 12 may control the operation of the power conversion circuit to stop supplying power to the cartridge heater 24 and/or the heater 18 based on the temperature of the cartridge heater 24 and/or the heater 18 exceeding a preset temperature limit. For example, the controller 12 may reduce the amount of power supplied to the cartridge heater 24 and/or the heater 18 by a predetermined proportion, based on the temperature of the cartridge heater 24 and/or the heater 18 exceeding the preset temperature limit. For example, the controller 12 may determine that the aerosol-generating material accommodated in the cartridge is exhausted based on the temperature of the cartridge heater 24 exceeding the temperature limit and may cut off the supply of power to the cartridge heater 24.

In an embodiment, the controller 12 may control the charging and discharging of the power source 11. The controller 12 may verify the temperature of the power source 11 based on an output signal of the temperature sensor 13a.

In an embodiment, when a power line is connected to a battery terminal of the aerosol-generating device 1, the controller 12 may verify whether the temperature of the power source 11 is greater than or equal to a first temperature limit, which is the criterion for cutting off charging of the power source 11. The controller 12 may control the power source 11 to be charged based on the preset charging current when the temperature of the power source 11 is less than the first temperature limit. The controller 12 may cut off the charging of the power source 11 when the temperature of the power source 11 is greater than or equal to the first temperature limit.

In an embodiment, in a state in which the aerosol-generating device 1 is powered ON, the controller 12 may verify whether the temperature of the power source 11 is greater than or equal to a second temperature limit, which is the criterion for cutting off discharging of the power source 11. The controller 12 may control the power stored in the power source 11 to be used when the temperature of the power source 11 is less than the second temperature limit. The controller 12 may stop using the power stored in the power source 11 when the temperature of the power source 11 is greater than or equal to the second temperature limit.

In an embodiment, the controller 12 may calculate the remaining capacity for the power stored in the power source 11. For example, the controller 12 may calculate the remaining capacity of the power source 11 based on the voltage of the power source 11 and/or the value of current sensed.

In an embodiment, the controller 12 may determine whether the stick is inserted into the insertion space through the insertion detection sensor 13c. The controller 12 may determine that the stick is inserted based on an output signal from the insertion detection sensor 13c. When it is determined that the stick is inserted into the insertion space, the controller 12 may control to supply power to the cartridge heater 24 and/or the heater 18. For example, the controller 12 may supply power to the cartridge heater 24 and/or the heater 18 based on the temperature profile stored in the memory 17.

In an embodiment, the controller 12 may determine whether the stick is removed from the insertion space. For example, the controller 12 may determine whether the stick is removed from the insertion space through the insertion detection sensor 13c. For example, the controller 12 may determine that the stick is removed from the insertion space when the temperature of the heater 18 is greater than or equal to a temperature limit or when the gradient of the temperature change of the heater 18 is greater than or equal to a set gradient. When it is determined that the stick is removed from the insertion space, the controller 12 may cut off the supply of power to the cartridge heater 24 and/or the heater 18.

In an embodiment, the controller 12 may control the time of power supply and/or the amount of power supply to the heater 18 depending on the state of the stick sensed by the sensor 13. The controller 12 may verify a level range including the level of a signal of the capacitance sensor based on a lookup table. The controller 12 may determine the amount of moisture in the stick according to the verified level range.

In an embodiment, when the stick is in an over-humidified state, the controller 12 may increase the preheating time of the stick compared to the case in which the stick is in a normal state, by controlling the time of power supply to the heater 18.

In an embodiment, the controller 12 may determine whether the stick inserted into the insertion space is reused through the reuse detection sensor 13d. For example, the controller 12 may compare a sensed value of a signal of the reuse detection sensor 13d with a first reference range including a first color, and when the sensed value falls within the first reference range, determine that the stick is unused. For example, the controller 12 may compare the sensed value of the signal of the reuse detection sensor 13d with a second reference range including a second color, and when the sensed value falls within the second reference range, determine that the stick is used. When it is determined that the stick is used, the controller 12 may cut off the supply of power to the cartridge heater 24 and/or the heater 18.

In an embodiment, the controller 12 may determine whether the cartridge is coupled and/or decoupled through the cartridge detection sensor 13e. For example, the controller 12 may determine whether the cartridge is coupled and/or decoupled based on a sensed value of a signal of the cartridge detection sensor 13e.

In an embodiment, the controller 12 may determine whether the aerosol-generating material in the cartridge is exhausted. For example, the controller 12 may preheat the cartridge heater 24 and/or the heater 18 by applying power, determine whether the temperature of the cartridge heater 24 exceeds the temperature limit in a preheating period, and determine that the aerosol-generating material in the cartridge is exhausted when the temperature of the cartridge heater 24 exceeds the temperature limit. When it is determined that the aerosol-generating material in the cartridge is exhausted, the controller 12 may cut off the supply of power to the cartridge heater 24 and/or the heater 18.

In an embodiment, the controller 12 may determine whether the cartridge is unusable. For example, the controller 12 may determine that the cartridge is unusable when the current number of puffs is greater than or equal to the maximum number of puffs set in the cartridge based on the data stored in the memory 17. For example, the controller 12 may determine that the cartridge is unusable when the total time for which the heater 24 is heated is greater than or equal to a preset maximum time or when the total amount of power supplied to the heater 24 is greater than or equal to a preset maximum amount of power.

In an embodiment, the controller 12 may perform a determination about the inhalation of the user through the puff sensor 13b. For example, the controller 12 may determine whether a puff occurs based on a sensed value of a signal of the puff sensor 13b. For example, the controller 12 may determine the strength of the puff based on the sensed value of the signal of the puff sensor 13b. When the number of puffs reaches the preset maximum number of puffs or when a puff is not detected for more than a preset time, the controller 12 may cut off the supply of power to the cartridge heater 24 and/or the heater 18.

In an embodiment, the controller 12 may determine whether the cap is coupled and/or decoupled through the cap detection sensor 13f. For example, the controller 12 may determine whether the cap is coupled and/or decoupled based on a sensed value of a signal of the cap detection sensor 13f.

In an embodiment, the controller 12 may control the outputter 14 based on the sensing result obtained by the sensor 13. For example, when the number of puffs counted through the puff sensor 13b reaches the preset number, the controller 12 may inform the user that the aerosol-generating device 1 is to be ended soon through at least one of the display 14a, the haptic portion 14b, and the sound outputter 14c. For example, the controller 12 may inform the user through the outputter 14 based on the determination that the stick is absent from the insertion space. For example, the controller 12 may inform the user through the outputter 14 based on the determination that the cartridge and/or the cap is not mounted. For example, the controller 12 may provide information on the temperature of the cartridge heater 24 and/or the heater 18 to the user through the outputter 14.

In an embodiment, based on the occurrence of a predetermined event, the controller 12 may store and update the history of the event that occurred in the memory 17. The event may include the detection of inserting the stick, the initiation of heating the stick, the detection of puffs, the end of puffs, the detection of overheating the cartridge heater 24 and/or the heater 18, the detection of applying overvoltage to the cartridge heater 24 and/or heater the 18, the end of heating the stick, the operation of powering ON/OFF the aerosol-generating device 1, the initiation of charging the power source 11, the detection of overcharging the power source 11, the end of charging the power source 11, or the like, performed by the aerosol-generating device 1. The history of the event may include the date and time the event occurred, log data corresponding to the event, and the like. For example, when the predetermined event is the detection of inserting the stick, the log data corresponding to the event may include data on the sensed value of the insertion detection sensor 13c or the like. For example, when the predetermined event is the detection of overheating the cartridge heater 24 and/or the heater 18, the log data corresponding to the event may include data on the temperature of the cartridge heater 24 and/or the heater 18, the voltage applied to the cartridge heater 24 and/or the heater 18, the current flowing in the cartridge heater 24 and/or the heater 18, and the like.

In an embodiment, the controller 12 may control to form a communication link with an external device, such as a mobile terminal of the user. When authentication data is received from the external device via the communication link, the controller 12 may remove restrictions on the use of at least one function of the aerosol-generating device 1. Here, the authentication data may include data indicating the completion of user authentication for the user corresponding to the external device. The user may perform user authentication through the external device. The external device may determine whether user data is valid based on the date of birth of the user, a unique number that identifies the user, and the like, and receive data on the authority to use the aerosol-generating device 1 from an external server. The external device may transmit data indicating the completion of user authentication to the aerosol-generating device 1 based on the data on the authority to use. In response to the completion of the user authentication, the controller 12 may remove restrictions on the use of at least one function of the aerosol-generating device 1. For example, in response to the completion of the user authentication, the controller 12 may remove restrictions on the use of a heating function that supplies power to the heater 18.

In an embodiment, the controller 12 may transmit state data of the aerosol-generating device 1 to the external device via the communication link with the external device. Based on the received state data, the external device may output the remaining capacity, the operation mode, and the like of the power source 11 of the aerosol-generating device 1 through a display of the external device.

In an embodiment, the external device may transmit a location search request to the aerosol-generating device 1 based on an input that initiates a location search for the location of the aerosol-generating device 1. When the location search request is received from the external device, the controller 12 may control at least one of output devices to perform an operation corresponding to the location search based on the received location search request. For example, in response to the location search request, the haptic portion 14b may generate vibrations. For example, in response to the location search request, the display 14a may output an object corresponding to the location search and the end of the search.

In an embodiment, when firmware data is received from the external device, the controller 12 may control to perform a firmware update. The external device may check the current version of the firmware of the aerosol-generating device 1 and determine whether a new version of the firmware is present. When an input that requests a firmware download is received, the external device may receive a new version of firmware data and transmit the new version of firmware data to the aerosol-generating device 1. When the new version of firmware data is received, the controller 12 may control to update the firmware of the aerosol-generating device 1.

In an embodiment, the controller 12 may transmit data on the sensed value of at least one sensor 13 through the communicator 16 to an external server (not shown), receive a training model generated by training the sensed value through machine learning, such as deep learning, from the external server, and store the training model. The controller 12 may perform an operation of determining an inhalation pattern of the user, an operation of generating a temperature profile, and the like using the training model received from the external server. The controller 12 may store, in the memory 17, the sensed value data of at least one sensor 13 and the data used to train an artificial neural network (ANN). For example, the memory 17 may store a database for each component provided in the aerosol-generating device 1, weights that form the structure of the ANN, and biases, for training the ANN. The controller 12 may generate at least one training model that trains the data on the sensed value of at least one sensor 13, the inhalation pattern of the user, the temperature profile, and the like, which are stored in the memory 17, and is used to determine the inhalation pattern of the user and generate the temperature profile.

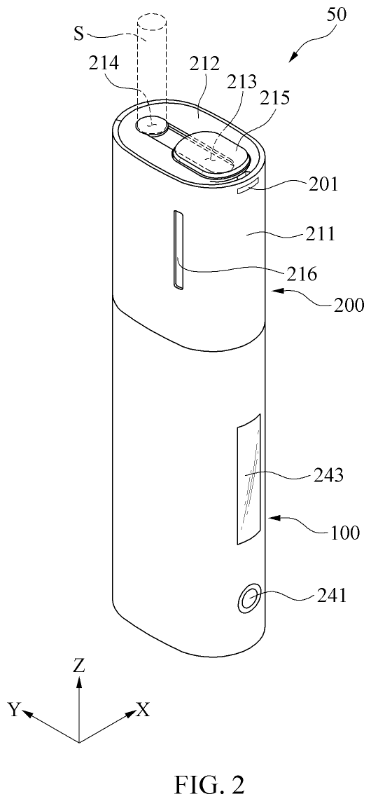

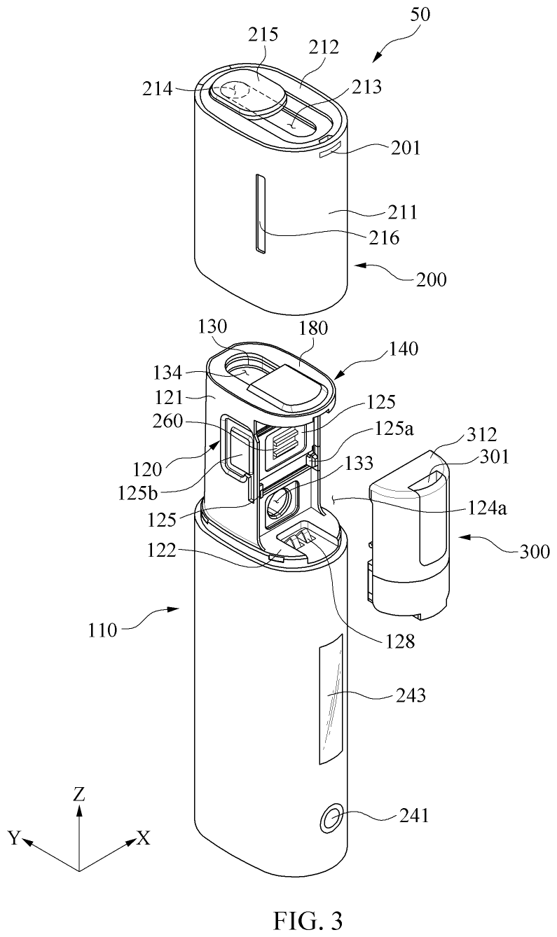

FIG. 2 is a perspective view illustrating an aerosol-generating device 50 according to an embodiment, and FIG. 3 is an exploded perspective view illustrating the aerosol-generating device 50 according to an embodiment.

Referring to FIGS. 2 and 3, the aerosol-generating device 50 (e.g., the aerosol-generating device 1 of FIG. 1) according to an embodiment of the present disclosure may include at least a portion of a main body 100 and a case 200.

Hereinafter, the description provided above is not repeated, and it is obvious that a portion of the configuration and structure of the aerosol-generating device 50 may be replaced, added, or omitted within a scope easily understandable by one of ordinary skill in the art with reference to the following diagrams and descriptions. In addition, at least one component or feature of the embodiments described above may be coupled to the aerosol-generating device 50 unless this is technically and clearly infeasible.

In an embodiment, the main body 100 may include a first body 110 and a second body 120. The second body 120 may be located above the first body 110 (e.g., a +Z direction). The first body 110 may be elongated vertically (e.g., a Z-axis direction). The main body 100 may accommodate components for driving devices therein.

In an embodiment, the second body 120 may provide an insertion space 134 that is opened upward. The insertion space 134 may be located inside the second body 120. The insertion space 134 may be elongated vertically. The insertion space 134 may be formed in a pipe 130 located inside the second body 120.

In an embodiment, the case 200 may have a downward-opening (e.g., a −Z direction) hollow shape. The second body 120 may be inserted into the hollow of the case 200. The case 200 may be detachably coupled to the main body 100. The case 200 may surround and cover the second body 120.

In an embodiment, a lateral portion 211 of the case 200 may surround and cover a side wall 121 of the second body 120. An upper portion 212 of the case 200 may cover an upper portion of the second body 120 or a cover 180. When the case 200 is coupled to the main body 100, the case 200 may cover both the main body 100 and a cartridge 300. The cartridge 300 may be disposed inside the case 200.

In an embodiment, an insertion hole 214 may be open, forming the upper portion 212 of the case 200. The insertion hole 214 may correspond to an opening of the insertion space 134. A cap 215 may be movably installed in the upper portion 212 of the case 200. A slide hole 213 may extend from the insertion hole 214 to one side on the upper portion 212 of the case 200. The cap 215 may move along the slide hole 213. The cap 215 may open and close the insertion hole 214 and the insertion space 134. A stick S may be inserted into the insertion space 134 through the insertion hole 214. For example, the stick S may be a cigarette.

In an embodiment, the side wall 121 and a partition wall 125 may form a lateral portion of the second body 120. The side wall 121 and the partition wall 125 may be connected to each other. The side wall 121 may be covered by an inner surface of the case 200. The partition wall 125 may separate a cartridge coupling space 124a from the insertion space 134.

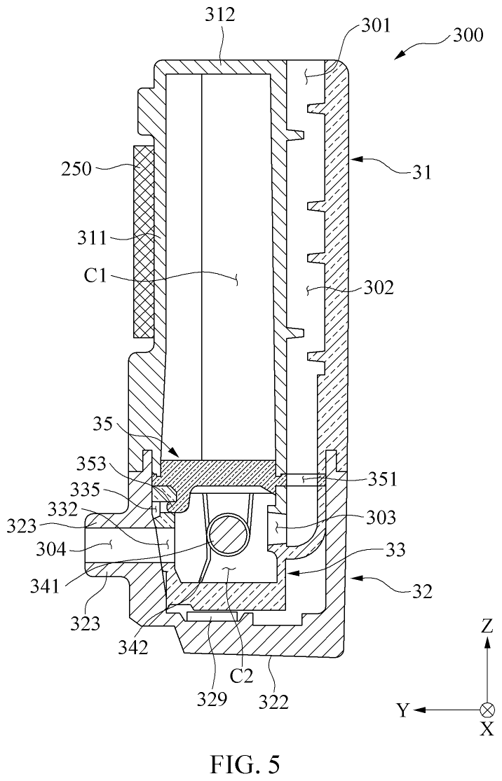

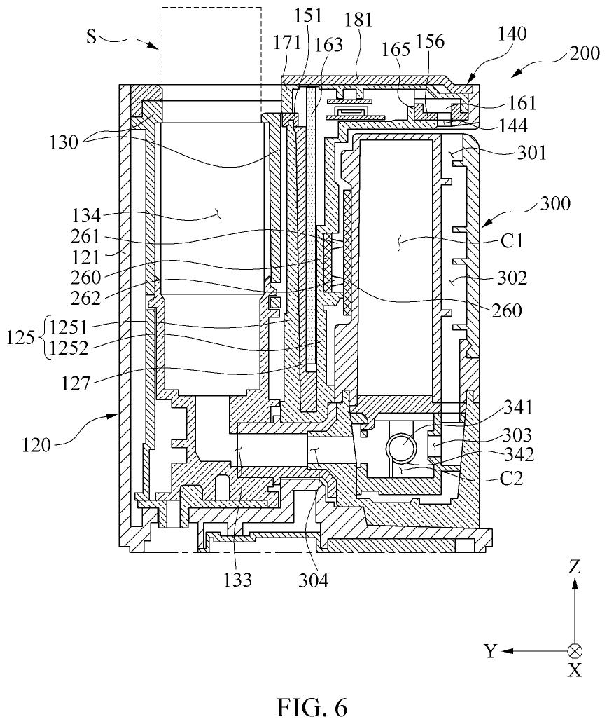

In an embodiment, the partition wall 125 may be disposed to face the cartridge 300. For example, the partition wall 125 may face a chamber (e.g., a chamber C1 of FIGS. 5 and 6) of the cartridge 300, which stores a liquid aerosol-generating material.

In an embodiment, the second body 120 may include a seating portion 122. The seating portion 122 may extend to one side from a lower portion of the partition wall 125. The seating portion 122 may be formed on the upper side of the first body 110. The seating portion 122 may cover a lower portion of the cartridge coupling space 124a. A bottom surface of the cartridge 300 may sit on and be supported by the seating portion 122.

In an embodiment, the second body 120 may include an extension 140. The extension 140 may extend to one side from an upper portion of the partition wall 125. The extension 140 may extend in a direction in which the seating portion 122 is formed. The extension 140 may cover an upper portion of the cartridge coupling space 124a. The extension 140 may cover an upper surface of the cartridge 300. The extension 140 may cover a cartridge inlet 301 formed in the cartridge 300. A gap, through which air may flow, may be formed between the extension 140 and the cartridge inlet 301.

In an embodiment, the cartridge coupling space 124a may be formed on one side of the second body 120. The cartridge coupling space 124a may be defined by the seating portion 122, the partition wall 125, and the extension 140 of the second body 120. The bottom of the cartridge coupling space 124a may be covered by the seating portion 122. One side of the cartridge coupling space 124a may be covered by the partition wall 125 of the second body 120. An upper portion of the cartridge coupling space 124a may be covered by the extension 140. The cartridge coupling space 124a may be open outward between the seating portion 122 and the extension 140.

In an embodiment, the cartridge 300 may be inserted into the cartridge coupling space 124a and coupled to the main body 100. The cartridge 300 may be detachably coupled to the main body 100. A lateral surface 311 of the cartridge 300 may face the partition wall 125. An upper surface 312 of the cartridge 300 may be covered by the extension 140. A bottom surface 322 of the cartridge 300 may sit on the seating portion 122. A cartridge terminal 128 may be connected to the cartridge 300 and supply power to a heater 342 inside the cartridge 300.

In an embodiment, a coupling hook 125a may be formed in the second body 120. A pusher 125b may be formed in the second body 120. The coupling hook 125a and the pusher 125b may be formed on both sides as a pair and located facing each other. The cartridge 300 may include a hook-coupling groove 315. The hook-coupling groove 315 may be formed at a location corresponding to the coupling hook 125a. When the cartridge 300 is inserted into the cartridge coupling space 124a, the coupling hook 125a may be coupled to the hook-coupling groove 315 and may couple the cartridge 300 to the main body 100. The pusher 125b and the coupling hook 125a may be interlinked to move together. Pressing the pusher 125b may cause the coupling hook 125a to move in the direction of being detached from the hook-coupling groove 315, allowing the cartridge 300 to be detached from the main body 100.

In an embodiment, a connecting flow path 133 may be formed in a lower portion of the partition wall 125. The connecting flow path 133 may communicate with the insertion space 134. The connecting flow path 133 may be open to one side of the second body 120. When the cartridge 300 is coupled to the main body 100, a discharge port 323 may be inserted into the connecting flow path 133, and the connecting flow path 133 and a cartridge outlet 304 may communicate with each other.

In an embodiment, a level sensor 260 may be provided in the main body 100. For example, the level sensor 260 may be disposed in the partition wall 125 of the second body 120. The level sensor 260 may be a component of a sensor (e.g., the sensor 13 of FIG. 1) of the aerosol-generating device 50. The level sensor 260 may sense the capacity or water level of the liquid aerosol-generating material stored in a chamber C1. The level sensor 260 may be a water level sensor or a capacity sensor.

In an embodiment, a button 241 may be provided in the main body 100. For example, the button 241 may be disposed on an outer side surface of the first body 110. The button 241 may be a component of an inputter (e.g., the inputter 15 of FIG. 1) of the aerosol-generating device 50. The user may turn the aerosol-generating device 50 on/off by pressing the button 241. Alternatively, the user may provide an input signal to the aerosol-generating device 50 in various ways, such as by pressing, rotating, or haptically pressing the button 241.

In an embodiment, a display 243 may be provided in the main body 100. For example, the display 243 may be disposed on the outer side surface of the first body 110. The display 243 may be a component (e.g., the display 14a of FIG. 1) of an outputter (e.g., the outputter 14 of FIG. 1) of the aerosol-generating device 50. The display 243 may visually display various pieces of information about driving, such as a driving state of the aerosol-generating device 50, battery information, and capacity information of the liquid aerosol-generating material.

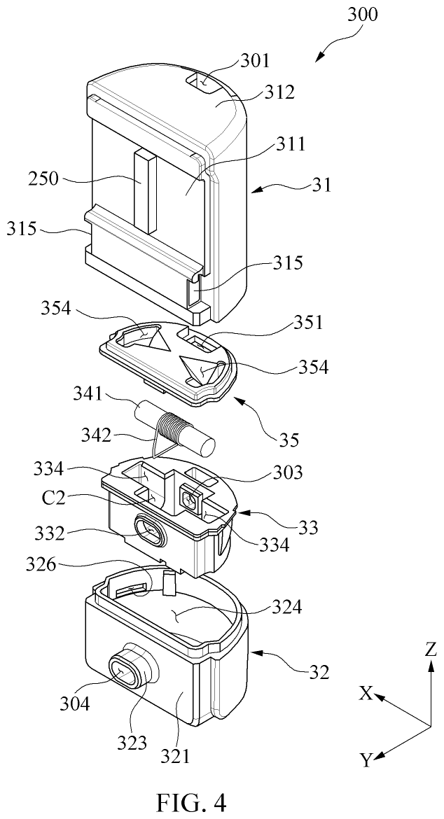

FIG. 4 is an exploded perspective view illustrating the cartridge 300 of the aerosol-generating device 50, according to an embodiment, and FIG. 5 is a cross-sectional view illustrating the cartridge 300 of the aerosol-generating device 50, according to an embodiment.

Referring to FIGS. 4 and 5, the cartridge 300 may include a first container 31 and a second container 32.

Hereinafter, the description provided above is not repeated, and it is obvious that a portion of the configuration and structure of the cartridge 300 and the aerosol-generating device 50 including the same may be replaced, added, or omitted within a scope easily understandable by one of ordinary skill in the art with reference to the following diagrams and descriptions. In addition, at least one component or feature of the embodiments described above may be coupled to the cartridge 300 and the aerosol-generating device 50 including the same unless this is technically and clearly infeasible.

In an embodiment, the first container 31 may be coupled to an upper side of the second container 32. A plate 35 may be coupled between the first container 31 and the second container 32 or between the first container 31 and a frame 33.

In an embodiment, the first container 31 may have the chamber C1 for storing a liquid aerosol-generating material therein. The first container 31 may surround the chamber C1, and a lower portion of the chamber C1 may be open. An opening of the chamber C1 may be covered by the plate 35. The chamber C1 may be a first chamber, a main chamber, a cartridge chamber, or a reservoir.

In an embodiment, the first container 31 may have an inflow path 302 through which air passes. The chamber C1 and the inflow path 302 may be separated from each other. The inflow path 302 may be elongated vertically on one side of the first container 31.

In an embodiment, the first container 31 may have the cartridge inlet 301. The cartridge inlet 301 may be open, forming an upper portion of the first container 31, and may communicate with the inflow path 302. The cartridge inlet 301 may communicate with an upper end of the inflow path 302. A lower end of the inflow path 302 may communicate with a connecting hole 351 and a chamber inlet 303.

In an embodiment, the second container 32 may be coupled to a lower portion of the first container 31. The second container 32 may have a space 324 with an open top and a covered bottom. The frame 33 may be accommodated inside the space 324 of the second container 32.

In an embodiment, the second container 32 may have the cartridge outlet 304. The cartridge outlet 304 may be formed in a lateral portion 321 of the second container 32.

In an embodiment, the cartridge outlet 304 may be formed inside a port protruding in the thickness direction from a lateral portion of the second container 32. The cartridge outlet 304 may communicate with the space 324. The second container 32 may include the discharge port 323.

In an embodiment, the discharge port 323 may form the cartridge outlet 304 therein. The discharge port 323 may protrude to one side from the lateral portion 321 of the second container 32. The discharge port 323 may surround the cartridge outlet 304. The cartridge outlet 304 may be referred to as an outlet.

In an embodiment, the frame 33 may be inserted into the space 324 inside the second container 32 and coupled to the second container 32. A fastening member 326 protruding from a lateral wall of the second container 32 to the space 324 may be fastened to the frame 33 to secure the frame 33.

In an embodiment, the frame 33 may have an atomization chamber C2 therein. The frame 33 may surround the atomization chamber C2, and an upper portion of the atomization chamber C2 may be open. An upper portion of the atomization chamber C2 may be covered by the plate 35. The atomization chamber C2 may be a second chamber or an atomization space.

In an embodiment, the frame 33 may have the chamber inlet 303. One surface of a lateral wall surrounding the atomization chamber C2 may be open, forming the chamber inlet 303. The chamber inlet 303 may bend and extend upward from the atomization chamber C2 toward the inflow path 302. One end of the chamber inlet 303 may communicate with the atomization chamber C2, and the other end of the chamber inlet 303 may be connected to the inflow path 302 and the connecting hole 351.

In an embodiment, the frame 33 may have a chamber outlet 332. The chamber outlet 332 may be formed in a lateral portion of the frame 33. The chamber outlet 332 may communicate with the atomization chamber C2. The chamber outlet 332 may be formed inside a port protruding from the lateral portion of the frame 33 in the thickness direction.

In an embodiment, the chamber outlet 332 may communicate with the atomization chamber C2. The chamber outlet 332 may be formed at a location corresponding to the cartridge outlet 304. The chamber outlet 332 may be formed at a location that is opposite to the chamber inlet 303 with respect to the atomization chamber C2. When the frame 33 is coupled to the second container 32, the chamber outlet 332 and the cartridge outlet 304 may communicate with each other.

In an embodiment, the frame 33 may have a wick-coupling groove 334 therein. The wick-coupling groove 334 may communicate with the atomization chamber C2. The wick-coupling groove 334 may be recessed to one side, forming the atomization chamber C2. The wick-coupling groove 334 may be formed in pairs, and a pair of wick-coupling grooves 334 may be formed to be located on opposite sides in the atomization chamber C2. An upper portion of the wick-coupling groove 334 may be open.

In an embodiment, a wick 341 may have a horizontally elongated cylindrical shape in the atomization chamber C2. Each end of the wick 341 may be inserted into a corresponding one of the pair of wick-coupling grooves 334. The center of the wick 341 may be located in the atomization chamber C2. The wick 341 may be connected to the chamber C1 and receive a liquid aerosol-generating material from the chamber C1. The wick 341 may be fixed to the wick-coupling groove 334 by the frame 33 and the plate 35.

In an embodiment, the heater 342 may be wound around the center of the wick 341. The heater 342 may be heated and heat the wick 341. For example, the heater 342 may be a resistive heater. The heater 342 may be disposed in the atomization chamber C2. An end of the heater 342 may pass through the bottom of the frame 33 and be electrically connected to an electrode disposed at the bottom of the second container 32.

In an embodiment, the plate 35 may be coupled between the first container 31 and the second container 32 or between the first container 31 and the frame 33. The plate 35 of the frame 33 may cover and seal an opening of the chamber C1. The plate 35 may cover the upper portion of the frame 33. The plate 35 may cover and seal an opening of the atomization chamber C2.

In an embodiment, the plate 35 may have the connecting hole 351 on one side. The connecting hole 351 may be located between the inflow path 302 and the chamber inlet 303. The connecting hole 351 may connect the inflow path 302 to the chamber inlet 303.

In an embodiment, the plate 35 may have a liquid inflow hole 354. The liquid inflow hole 354 may be formed in pairs at a location corresponding to the wick-coupling groove 334. A pair of liquid inflow holes 354 may be located in the upper sides of both ends of the wick 341. The liquid inflow hole 354 may connect the chamber C1 to the wick-coupling groove 334. The wick 341 may be connected to the chamber C1 through the liquid inflow hole 354.

In an embodiment, a hook groove 335 may be formed on an upper side of the chamber outlet 332 at a location that is adjacent to the chamber outlet 332. A hook 353 may protrude downward from one side of the plate 35. The hook 353 may be inserted into and fastened to the hook groove 335 formed in the upper portion of the frame 33. The plate 35 may be fastened to the frame 33, and the first container 31 coupled to the second container 32 may press an edge of the plate 35 toward the frame 33.

In an embodiment, the user may hold the stick S inserted into the insertion space 134 in the mouth of the user and inhale air. When the case 200 is coupled to the main body 100, air may flow into the cartridge inlet 301 through an opening 201 formed in the case 200. Air may enter the inside of the cartridge 300 through the cartridge inlet 301 and be discharged to the outside of the cartridge 300 through the cartridge outlet 304. Air entering the cartridge 300 may sequentially pass through the inflow path 302, the connecting hole 351, the chamber inlet 303, the atomization chamber C2, the chamber outlet 332, and the cartridge outlet 304 and be discharged to the outside.

In an embodiment, when the heater 342 heats the wick 341, an aerosol may be generated from the wick 341 in the atomization chamber C2. Air passing through the cartridge 300, accompanied by the aerosol from the atomization chamber C2, may be discharged to the cartridge outlet 304. Air discharged through the cartridge outlet 304 may be supplied to the insertion space 134 and the stick S inserted into the insertion space 134 through the connecting flow path 133.

FIG. 6 is a partial cross-sectional view illustrating the aerosol-generating device 50 according to an embodiment.

Referring to FIG. 6, the second body 120 may have the side wall 121 and the partition wall 125. The side wall 121 and the partition wall 125 may be connected to each other. The partition wall 125 may extend vertically between the pipe 130 and the cartridge coupling space 124a.

Hereinafter, the description provided above is not repeated, and it is obvious that a portion of the configuration and structure of the aerosol-generating device 50 may be replaced, added, or omitted within a scope easily understandable by one of ordinary skill in the art with reference to the following diagrams and descriptions. In addition, at least one component or feature of the embodiments described above may be coupled to the aerosol-generating device 50 unless this is technically and clearly infeasible.

In an embodiment, the extension 140 may extend to one side from the upper portion of the second body 120. The upper surface 312 of the cartridge 300 may be covered by the extension 140. The extension 140 may cover the cartridge inlet 301 and the vicinity of the cartridge inlet 301. A gap may be formed between the extension 140 and the cartridge inlet 301 and between the lower portion of the extension 140 and the upper surface 312 of the cartridge 300. The gap may allow the cartridge inlet 301 to communicate with the outside.

In an embodiment, the pipe 130 may be elongated vertically. The pipe 130 may have a hollow structure. The insertion space 134 may be formed inside the pipe 130. The insertion space 134 may be open upward. The insertion space 134 may extend vertically. The connecting flow path 133 may be formed inside the pipe 130. The connecting flow path 133 may be formed on a lower side of the insertion space 134. One end of the connecting flow path 133 may communicate with the outside of the pipe 130 and the other end of the connecting flow path 133 may communicate with the insertion space 134. The connecting flow path 133 may bend to one side from the lower portion of the insertion space 134.

In an embodiment, an airflow sensor 161 may be installed inside the extension 140. The airflow sensor 161 may face the upper surface of the cartridge 300 or the cartridge inlet 301. The airflow sensor 161 may be installed adjacent to the cartridge inlet 301. The airflow sensor 161 may be located on the upper side of the cartridge inlet 301. The airflow sensor 161 may overlap the cartridge inlet 301 in the vertical direction.

In an embodiment, the airflow sensor 161 may sense the flow of air around the airflow sensor 161. The airflow sensor 161 may be a pressure sensor. The airflow sensor 161 may sense the flow of air through changes in the surrounding air pressure. At a location adjacent to the cartridge inlet 301, the extension 140 may have a hole for sensing airflow. The airflow sensor 161 may be mounted on a substrate disposed inside the extension 140 and may be electrically connected to the controller 20. The controller 20 may control the operation of various connected components based on the airflow sensor 161 sensing the flow of air.

In an embodiment, a first sealing portion 151 may be disposed between a first partition wall portion 1251 and an inner plate 171. The first sealing portion 151 may wrap around and adhere to an upper end portion of the first partition wall portion 1251. The first sealing portion 151 may adhere to a lower end of the inner plate 171.

In an embodiment, a sensor accommodation portion 156 of a second sealing portion 152 may seal the vicinity of a first sensing hole 144. The sensor accommodation portion 156 may adhere to an extension plate 141 around the first sensing hole 144. A second sensing hole 1564 formed in the sensor accommodation portion 156 may communicate with the first sensing hole 144. The sensor accommodation portion 156 may wrap around and adhere to the airflow sensor 161. Accordingly, it may be possible to prevent a malfunction of the substrate or sensor due to a foreign substance or aerosol discharged around the opening of the pipe 130 or a foreign substance through the first sensing hole 144.

In an embodiment, a conductive member 250 may be provided on one surface of the chamber C1. For example, the conductive member 250 may be disposed on the lateral surface 311 of the cartridge 300 forming the chamber C1. The lateral surface 311 of the cartridge 300 may be a surface facing the partition wall 125 of the main body 100.

In an embodiment, the level sensor 260 may sense the capacity of the liquid aerosol-generating material stored in the chamber C1. The level sensor 260 may apply current to the conductive member 250 and measure a resistance value that varies depending on the capacity of the liquid aerosol-generating material.

In an embodiment, the conductive member 250 may be connected in series or parallel with the liquid aerosol-generating material stored in the chamber C1. A surface (e.g., the lateral surface 311) forming the chamber C1 may be formed of an electrically conductive material. For example, the chamber C1 may be formed of a conductive material having relatively lower conductivity than the conductive member 250. Alternatively, for example, the chamber C1 may be formed of a conductive resin, a conductive polymer material, or a conductive organic chemical.

In an embodiment, when the capacity of the liquid aerosol-generating material stored in the chamber C1 changes, the total resistance value of the conductive member 250 and the chamber C1 may change.

For example, when the capacity of the liquid aerosol-generating material inside the chamber C1 changes, the voltage applied to the conductive member 250 may change in a situation in which the same current is applied. Alternatively, for example, when the capacity of the liquid aerosol-generating material inside the chamber C1 changes, the current flowing through the conductive member 250 may change in a situation in which the same voltage is applied.

In an embodiment, the level sensor 260 may measure a change in resistance of the conductive member 250 and the chamber C1 by flowing current to the conductive member 250 and may sense the capacity of the liquid aerosol-generating material stored in the chamber C1 or a change in capacity.

In an embodiment of the present disclosure, the level sensor 260 may sense a change in the capacity of the liquid aerosol-generating material inside the chamber C1 by using the conductive member 250, and the detection accuracy of the level sensor 260 may be improved.

For example, the dielectric constant of the liquid aerosol-generating material may change depending on various factors such as a raw material, concentration, and composition ratio of the liquid aerosol-generating material. When the cartridge 300 is replaced and the dielectric constant of the liquid aerosol-generating material changes, errors may occur in measuring the capacity of the liquid aerosol-generating material by the level sensor 260.

In an embodiment of the present disclosure, the conductive member 250 may be disposed to directly contact one surface of the chamber C1, thereby being sensitive to a change in the capacity of the liquid aerosol-generating material. The level sensor 260 may measure the change in capacity of the liquid aerosol-generating material inside the chamber C1 by applying the current or voltage to the conductive member 250 and measuring the change in resistance of both the conductive member 250 and the chamber C1 so that errors of the level sensor 260 may be reduced and the accuracy may be improved. In addition, according to an embodiment of the present disclosure, since the aerosol-generating device 50 may be easily implemented by arranging the conductive member 250 and the level sensor 260, the efficiency in manufacturing the aerosol-generating device 50 may be improved.

In an embodiment, the level sensor 260 may transmit the detection result to at least one processor (e.g., the controller 12 of FIG. 1). The at least one processor may control the driving of the aerosol-generating device 50 based on the detection result received from the level sensor 260.

For example, the at least one processor may transmit, to the user, information about the remaining amount of liquid aerosol-generating material stored in the chamber C1 through an outputter (e.g., the outputter 14 of FIG. 1) or a display (e.g., the display 14a of FIG. 1 or the display 243 of FIGS. 2 and 3).

In an embodiment, the level sensor 260 may include a unit of electrodes 261 and 262. The unit of electrodes 261 and 262 may be arranged to face the conductive member 250. The conductive member 250 may be electrically connected to or contact the unit of electrodes 261 and 262 of the level sensor 260.

In an embodiment, the unit of electrodes 261 and 262 may include a first electrode 261 and a second electrode 262. The first electrode 261 and the second electrode 262 may be arranged to be spaced apart from each other and may contact two portions of the conductive member 250, respectively.

However, the structure and contact method of the unit of electrodes 261 and 262 and the conductive member 250 are not limited to the structure of the diagram, and the arrangement, structure, and quantity of the unit of electrodes 261 and 262 may also be implemented in various ways in response to the arrangement, structure, and quantity of the conductive member 250.

In an embodiment, the conductive member 250 may be formed in a bar shape extending along the direction (e.g., a Z-axis direction) in which the chamber C1 extends. Accordingly, the level sensor 260 may effectively sense the change in resistance of both the conductive member 250 and the chamber C1 according to the change in the capacity of the liquid aerosol-generating material in the chamber C1.

In an embodiment, the conductive member 250 may be coupled to the chamber C1 in a structure protruding from the lateral surface 311 of the chamber C1. Since the conductive member 250 has a protruding structure, the volume of the chamber C1 may be maintained. In addition, since a separate coupling structure is not required, the manufacturing efficiency of the aerosol-generating device 50 including the conductive member 250 and the level sensor 260 may be improved.

Hereinafter, according to various embodiments of the present disclosure, an example of the cartridge 300 including the conductive member 250 is described. However, this is an example, and the arrangement, shape, quantity, and structure of the conductive member 250 and the cartridge 300 are not limited thereto.

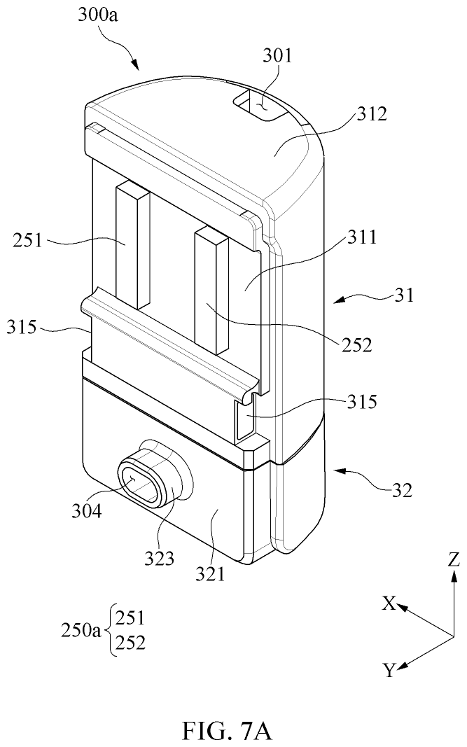

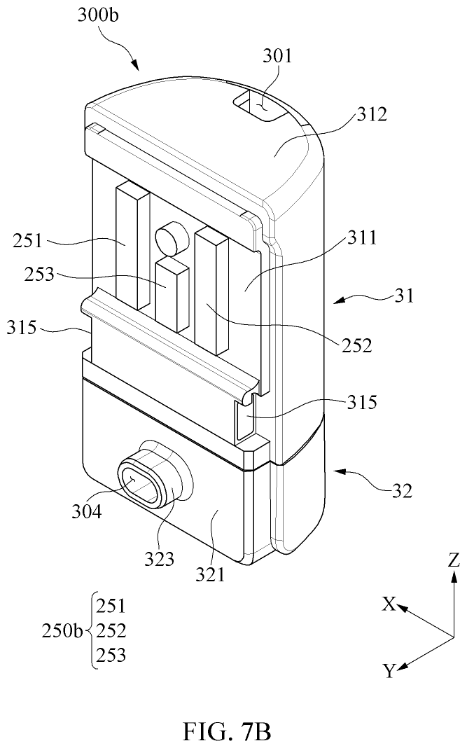

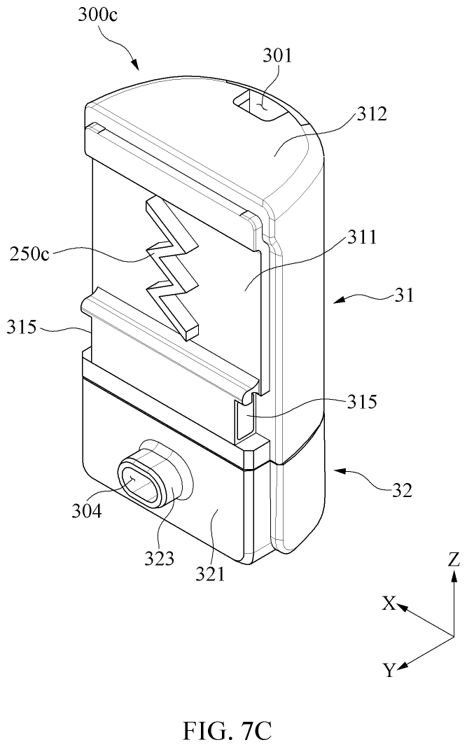

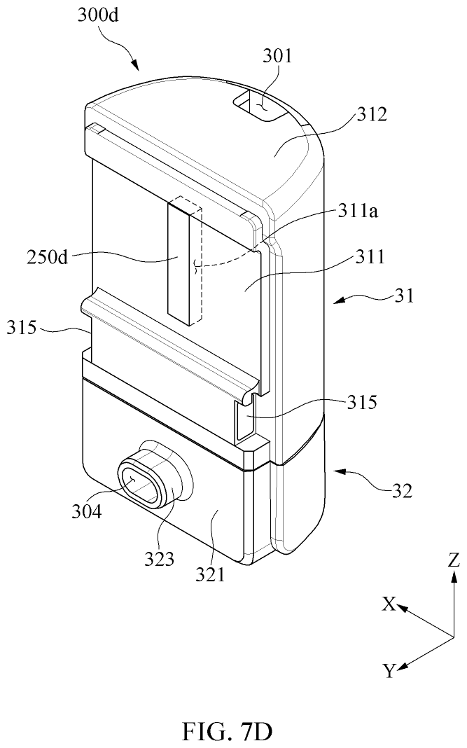

FIG. 7A is a perspective view illustrating a cartridge 300a of the aerosol-generating device 50, according to an embodiment.

Referring to FIG. 7A, the cartridge 300a (e.g., the cartridge 300 of FIGS. 3, 4, 5, and 6) according to an embodiment may include a conductive member 250a (e.g., the conductive member 250 of FIGS. 4, 5, and 6).

Hereinafter, the description provided above is not repeated, and it is obvious that a portion of the configuration and structure of the cartridge 300a and the aerosol-generating device 50 including the same may be replaced, added, or omitted within a scope easily understandable by one of ordinary skill in the art with reference to the following diagrams and descriptions. In addition, at least one component or feature of the embodiments described above may be coupled to the cartridge 300a and the aerosol-generating device 50 including the same unless this is technically and clearly infeasible.

In an embodiment, the conductive member 250a may include a first conductive region 251 and a second conductive region 252. The first conductive region 251 and the second conductive region 252 may be spaced apart from each other and disposed on the lateral surface 311 of the cartridge 300a.

In an embodiment, at least one processor (e.g., the controller 12 of FIG. 1) may receive the detection results of each of the first conductive region 251 and the second conductive region 252 and may correct the detection result of the level sensor 260 by using the detection results. The first conductive region 251 and the second conductive region 252 may reduce errors of the detection result of the level sensor 260 and improve the accuracy.

For example, the at least one processor may correct the detection result of the level sensor 260 by an average value of the detection results of each of the first conductive region 251 and the second conductive region 252. Alternatively, embodiments are not limited thereto, and the at least one processor may correct the detection result of the level sensor 260 by comparing two detection results with each other in various ways.

In an embodiment, the first conductive region 251 and the second conductive region 252 may be arranged parallel to each other. Each of the first conductive region 251 and the second conductive region 252 may be formed in a bar shape extending along the direction in which the chamber C1 extends.

In an embodiment, the first conductive region 251 and the second conductive region 252 may be formed of the same shape, thickness, length, and material. Since two conductive regions (e.g., the first conductive region 251 and the second conductive region 252) have the same condition, the at least one processor may correct the detection result of the level sensor 260 through a simple and easy correction procedure.

In an embodiment, the first conductive region 251 and the second conductive region 252 may be configured to have at least one different shape, thickness, length, and material and provide mutually different detection results, thereby reducing errors that may occur equally when two conductive regions (e.g., the first conductive region 251 and the second conductive region 252) have the same condition and helping to correct the detection result of the level sensor 260.

FIG. 7B is a perspective view illustrating a cartridge 300b of the aerosol-generating device 50, according to an embodiment.

Referring to FIG. 7B, the cartridge 300b (e.g., the cartridge 300 of FIGS. 3, 4, 5, and 6) according to an embodiment may include a conductive member 250b (e.g., the conductive member 250 of FIGS. 4, 5, and 6).

Hereinafter, the description provided above is not repeated, and it is obvious that a portion of the configuration and structure of the cartridge 300b and the aerosol-generating device 50 including the same may be replaced, added, or omitted within a scope easily understandable by one of ordinary skill in the art with reference to the following diagrams and descriptions. In addition, at least one component or feature of the embodiments described above may be coupled to the cartridge 300b and the aerosol-generating device 50 including the same unless this is technically and clearly infeasible.

In an embodiment, the conductive member 250b may include the first conductive region 251, the second conductive region 252, and an insulating region 253. The first conductive region 251 and the second conductive region 252 may be spaced apart from each other and disposed on the lateral surface 311 of the cartridge 300b.

In an embodiment, at least one processor (e.g., the controller 12 of FIG. 1) may receive the detection results of each of the first conductive region 251 and the second conductive region 252 and may correct the detection result of the level sensor 260 by using the detection results. The first conductive region 251 and the second conductive region 252 may reduce errors of the detection result of the level sensor 260 and improve the accuracy.

For example, the at least one processor may correct the detection result of the level sensor 260 by an average value of the detection results of each of the first conductive region 251 and the second conductive region 252. Alternatively, embodiments are not limited thereto, and the at least one processor may correct the detection result of the level sensor 260 by comparing two detection results with each other in various ways.

In an embodiment, the first conductive region 251 and the second conductive region 252 may be arranged parallel to each other. Each of the first conductive region 251 and the second conductive region 252 may be formed in a bar shape extending along the direction in which the chamber C1 extends.

In an embodiment, the first conductive region 251 and the second conductive region 252 may be formed of the same shape, thickness, length, and material. As two conductive regions (e.g., the first conductive region 251 and the second conductive region 252) have the same condition, the at least one processor may correct the detection result of the level sensor 260 through a simple and easy correction procedure.

In an embodiment, the first conductive region 251 and the second conductive region 252 may be configured to have at least one different shape, thickness, length, and material and provide mutually different detection results, thereby reducing errors that may occur equally when two conductive regions (e.g., the first conductive region 251 and the second conductive region 252) have the same condition and helping to correct the detection result of the level sensor 260.

In an embodiment, the insulating region 253 may be provided between the first conductive region 251 and the second conductive region 252. The insulating region 253 may be formed of a non-conductive material. The insulating region 253 may reduce or prevent electrical and/or electromagnetic interference between the first conductive region 251 and the second conductive region 252. The insulating region 253 may improve the accuracy of the detection result of the level sensor 260 by reducing or preventing the first conductive region 251 and the second conductive region 252 from mutually affecting each other.

FIG. 7C is a perspective view illustrating a cartridge 300c of the aerosol-generating device 50, according to an embodiment.

Referring to FIG. 7C, the cartridge 300c (e.g., the cartridge 300 of FIGS. 3, 4, 5, and 6) according to an embodiment may include a conductive member 250c (e.g., the conductive member 250 of FIGS. 4, 5, and 6).

Hereinafter, the description provided above is not repeated, and it is obvious that a portion of the configuration and structure of the cartridge 300c and the aerosol-generating device 50 including the same may be replaced, added, or omitted within a scope easily understandable by one of ordinary skill in the art with reference to the following diagrams and descriptions. In addition, at least one component or feature of the embodiments described above may be coupled to the cartridge 300c and the aerosol-generating device 50 including the same unless this is technically and clearly infeasible.

In an embodiment, the conductive member 250c may be formed in a shape that is bent at least one time and extends along the direction in which the chamber C1 extends. For example, the conductive member 250c may extend in a zigzag shape along the lateral surface 311 of the cartridge 300c. Alternatively, although not shown in the diagram, the conductive member 250c may have a shape that is bent at least one time. Alternatively, the conductive member 250c may have a semicircular, circular, elliptical, or vortex shape.

In an embodiment, the conductive member 250c may be formed in a bent or curved structure, thereby increasing an area in contact with the chamber C1, reacting more sensitively to the change in the capacity of the liquid aerosol-generating material, and improving the accuracy of the detection result of the level sensor 260.

FIG. 7D is a perspective view illustrating a cartridge 300d of the aerosol-generating device 50, according to an embodiment.

Referring to FIG. 7D, the cartridge 300d (e.g., the cartridge 300 of FIGS. 3, 4, 5, and 6) according to an embodiment may include a groove region 311a and a conductive member 250d (e.g., the conductive member 250 of FIGS. 4, 5, and 6).

Hereinafter, the description provided above is not repeated, and it is obvious that a portion of the configuration and structure of the cartridge 300d and the aerosol-generating device 50 including the same may be replaced, added, or omitted within a scope easily understandable by one of ordinary skill in the art with reference to the following diagrams and descriptions. In addition, at least one component or feature of the embodiments described above may be coupled to the cartridge 300d and the aerosol-generating device 50 including the same unless this is technically and clearly infeasible.

In an embodiment, the groove region 311a may be formed on the lateral surface 311 of the cartridge 300d. The groove region 311a may have a structure that is recessed in a direction facing the inside of the chamber C1 from the lateral surface 311. The groove region 311a may accommodate at least a portion of the conductive member 250d.

In an embodiment, the conductive member 250d may be disposed inside the groove region 311a. For example, one surface of the chamber C1 and the conductive member 250d may form a substantially flat surface. The conductive member 250d may be disposed inside the groove region 311a, thereby providing the coupling stability of the conductive member 250d, increasing an area in contact with the chamber C1, reacting more sensitively to the change in the capacity of the liquid aerosol-generating material, and improving the accuracy of the detection result of the level sensor 260.

Some embodiments of the disclosure described above or other embodiments are not mutually exclusive or distinct from each other. Some embodiments of the disclosure described above or other embodiments may be used jointly or combined with each other in configuration or function.

For example, a configuration A described in an embodiment and/or drawing and a configuration B described in another embodiment and/or drawing may be combined with each other. Namely, although the combination between the configurations is not directly described, the combination is possible except in cases where it is described that the combination is impossible.

The above detailed description should not be construed in all aspects as limiting and should be considered illustrative. The scope of the present disclosure should be determined by rational interpretation of the appended claims, and all variations within the scope of equivalents of the present disclosure are included in the scope of the present disclosure.

What is claimed is:

1. An aerosol-generating device comprising:
a chamber configured to store a liquid aerosol-generating material;
a main body comprising a partition wall facing the chamber;
a conductive member provided on one surface of the chamber facing the partition wall; and
a level sensor configured to sense an amount of the liquid aerosol-generating material stored in the chamber,
wherein the level sensor is configured to sense the amount of the liquid aerosol-generating material by applying current to the conductive member and measuring a voltage value that varies depending on a capacity of the liquid aerosol-generating material.

2. The aerosol-generating device of claim 1, wherein the level sensor comprises a unit of electrodes disposed to face the conductive member and configured to apply current to the conductive member.

3. The aerosol-generating device of claim 1, wherein the conductive member is formed in a bar shape extending along a direction in which the chamber extends.

4. The aerosol-generating device of claim 1, wherein the conductive member comprises a first conductive region and a second conductive region disposed to be spaced apart from each other.

5. The aerosol-generating device of claim 4, wherein the first conductive region and the second conductive region are arranged parallel to each other.

6. The aerosol-generating device of claim 4, wherein the first conductive region and the second conductive region are formed in the same shape.

7. The aerosol-generating device of claim 4, further comprising:
at least one processor configured to receive a detection result from the level sensor and configured to control driving of the aerosol-generating device,
wherein the at least one processor is configured to receive detection results of each of the first conductive region and the second conductive region and configured to correct the detection result of the level sensor.

8. The aerosol-generating device of claim 7, wherein the at least one processor is configured to correct the detection result of the level sensor by an average value of the detection results of each of the first conductive region and the second conductive region.

9. The aerosol-generating device of claim 4, further comprising:
an insulating region provided between the first conductive region and the second conductive region.

10. The aerosol-generating device of claim 1, wherein the conductive member is formed in a shape that is bent at least one time and extends along a direction in which the chamber extends.

11. The aerosol-generating device of claim 1, wherein the conductive member is coupled to the chamber in a structure protruding from the one surface of the chamber.

12. The aerosol-generating device of claim 1, wherein the chamber comprises a groove region formed in one surface to which the conductive member is coupled and configured to accommodate the conductive member.

13. The aerosol-generating device of claim 12, wherein the conductive member is disposed inside the groove region so that the one surface of the chamber and the conductive member form a flat surface.

14. The aerosol-generating device of claim 1, wherein the chamber is formed of a conductive resin, a conductive polymer material, or a conductive organic chemical.

15. The aerosol-generating device of claim 1, wherein the chamber is formed of a conductive material having relatively lower conductivity than the conductive member.
